(19) United States
(12) Patent Application Publication
(10) Pub. No.: US 2025/0307563 A1
(43) Pub. Date: Oct. 2, 2025

(54) PROMPT ORCHESTRATION FOR VIRTUAL AGENTS WITH DIGRESSION CAPABILITIES

(71) Applicant: BMC Coftware, Inc., Houston, TX (US)

(72) Inventors: Ajoy Kumar, Santa Clara, CA (US); Vijay Shastry, Pleasanton, CA (US); Narayan Kumar, Santa Clara, CA (US)

(21) Appl. No.: 18/622,841

(22) Filed: Mar. 29, 2024

(51) Int. Cl. G06F 40/35; G06F 40/40

(52) U.S. Cl. CPC G06F 40/35; G06F 40/40

(57) ABSTRACT

In described techniques, a request may be received at a virtual agent. The request may be processed at a router prompt to determine, from a language model, a topic prompt of a plurality of topic prompts associated with the request. The topic prompt and the request may be provided to the language model. A response to the request may be received from the language model and in response to the topic prompt and the request. Accordingly, the response may be provided using the virtual agent.

### TECHNICAL FIELD

This description relates to virtual agents.

### BACKGROUND

Conventional virtual agents, also known as chatbots, are used to provide assistance to users while reducing a need for human agents. For example, in the domain of Information Technology (IT) incident handling, either virtual or human agents may be used to implement structured processes defined by organizations or other entities to restore various IT services to specified operating levels. In more specific examples, users may contact a helpdesk when experiencing an IT problem such as malfunctioning software or hardware, or installation of new hardware/software. Through a series of interactions in which the problem is defined, isolated, and identified, one or more potential solutions may be provided to successfully restore or install the hardware or software.

As referenced above, human agents may be trained to provide user assistance in these and similar situations. Virtual agents have been implemented to reduce costs associated with providing user assistance while also reducing a wait time experienced by the users when receiving such assistance. Conventional virtual agents, however, are generally not capable of providing assistance at a level comparable to that of human agents.

Moreover, even to provide current levels of assistance, conventional virtual agents may require significant time and resources to be trained and deployed. For example, conventional virtual agents may be defined using scripted exchanges surrounding a single topic. Such scripted exchanges attempt to capture all possible interactions between a user and the virtual agent on the relevant topic. In addition to the effort required to achieve this level of scripting, resulting scripts may seem artificial to users and are susceptible to failure upon any question that extends slightly beyond the scripted exchange.

### SUMMARY

According to one general aspect, a computer program product may be tangibly embodied on a non-transitory computer-readable storage medium and may include instructions that, when executed by at least one computing device, are configured to cause the at least one computing device to receive a request at a virtual agent and process the request in response to a prompt to determine, from a language model, a topic prompt of a plurality of topic prompts associated with the request. When executed by the at least one computing device, the instructions may be further configured to cause the at least one computing device to provide the topic prompt and the request to the language model, receive, from the language model and in response to the topic prompt and the request, a response to the request, and provide the response using the virtual agent.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompa-nying drawings and the description below. Other features will be apparent from the description and drawings, and from the claims.

### BRIEF DESCRIPTION OF THE DRAWINGS

FIG. 1 is a block diagram of a system for prompt orchestration for virtual agents with digression capabilities.

FIG. 2 is a flowchart illustrating example operations of the system of FIG. 1.

FIG. 3 illustrates example prompts and prompt chaining used in the example system of FIG. 1.

FIG. 4 illustrates example prompt language for digression detection.

FIG. 5 is a block diagram illustrating a process flow for prompt chaining.

FIG. 6 is a block diagram illustrating a process flow for prompt chaining with detected digression.

FIG. 7 is a flowchart illustrating more detailed example operations of the system of FIG. 1.

### DETAILED DESCRIPTION

Described systems and techniques provide virtual agents that assist users in a natural, intuitive manner, including handling user-initiated topic digressions that may occur in an unpredictable manner. Further, described virtual agents may be created and deployed across a wide range of scenarios, without requiring scripting of agent/user exchanges for each such scenario.

As referenced above, typical methods for conversation design include, for example, intent classifier and dialog flows that are scripted with each back-and-forth agent to user conversation. Such systems are often difficult to configure and maintain, due to, e.g., extended training times as well as the need to manage complexity of the conversation through dialog flows.

Moreover, in a natural conversation, digressions occur when a user changes the topic of the conversation. For example, if a user is interacting with a virtual agent on a task such as ordering a new laptop, the user can, at any time, interrupt the dialog flow to either ask questions related to the order choices or ask something completely unrelated. Current chatbots generally attempt to handle digressions manually by pre-configuring all allowed conversation topic transitions using rigid workflows. This approach unfortunately leads to conversationally brittle chatbots that do not gracefully handle digressions when changes in the conversation topic go beyond pre-defined boundaries.

Described techniques leverage machine learning (ML) models, including large language models (LLMs), to provide virtual agents with natural language and digression handling capabilities. More specifically, in example embodiments, described techniques provide a conversation design that organizes topics in LLM prompts that are dynamically chained to provide conversation orchestration that handles digressions gracefully even when users jump from one topic to any other topic in unpredictable ways.

Existing LLMs have been trained to provide answers to specific questions or types of questions. However, such training may be expensive in terms of both processing requirements and time requirements. As a result, such approaches are not practical, particularly, e.g., for scenarios in which topics may be added or expanded over time. Moreover, such approaches do not address or solve the issue of digression handling.

Described techniques structure conversations between users and virtual agents using a set of prompts that are loosely coupled and dynamically chained, in conjunction with elicited responses from one or more LLMs. In such dynamic prompt chains, a subsequent prompt is predicted by a current prompt and corresponding LLM response.

In example implementations, each prompt is constructed in a declarative manner in conjunction with a corresponding topic, so that it is not necessary to specify each conversational turn or to otherwise order or script each conversation. Rather, one or more goal(s) of each unit of conversation may be specified for each prompt, so that each prompt may be considered complete (and a next or subsequent prompt predicted) once its corresponding goal or goals have been achieved.

Additionally, one or more digression detection prompts may be used to enable accurate detection of user-initiated digressions from a current topic. For example, a user may initially request assistance on a first topic, such as installing new software for a user. Described techniques may enact the types of prompt chaining described above to elicit and process information from the user. During included user exchanges, the user may spontaneously ask a question related to a different topic, such as a question regarding already-installed hardware.

Described techniques may recognize such a question as a digression from a current topic or incident and may save a current state of the current topic and/or incident (e.g., a most-recent response provided and/or a most-recent prompt used). Then, prompt routing and chaining for the digression topic may proceed until a digression answer is determined to have been provided. The saved state may then be retrieved so that prompt chaining of the original topic and/or incident may proceed to resolution.

Although existing systems attempt to handle digressions as referenced above, such digression handling techniques are rigid, pre-defined, and prone to failure when unanticipated digressions are experienced or when multiple digressions are experienced. In described techniques, a virtual agent may save a current state and jump to any required prompt needed to handle any digression, and then return to the saved state to reach resolution of an original topic. Moreover, described techniques may handle multiple successive digressions, e.g., digressions from digressions, by nesting saved states and successively returning to each saved state until all digressions and any original topic have been resolved.

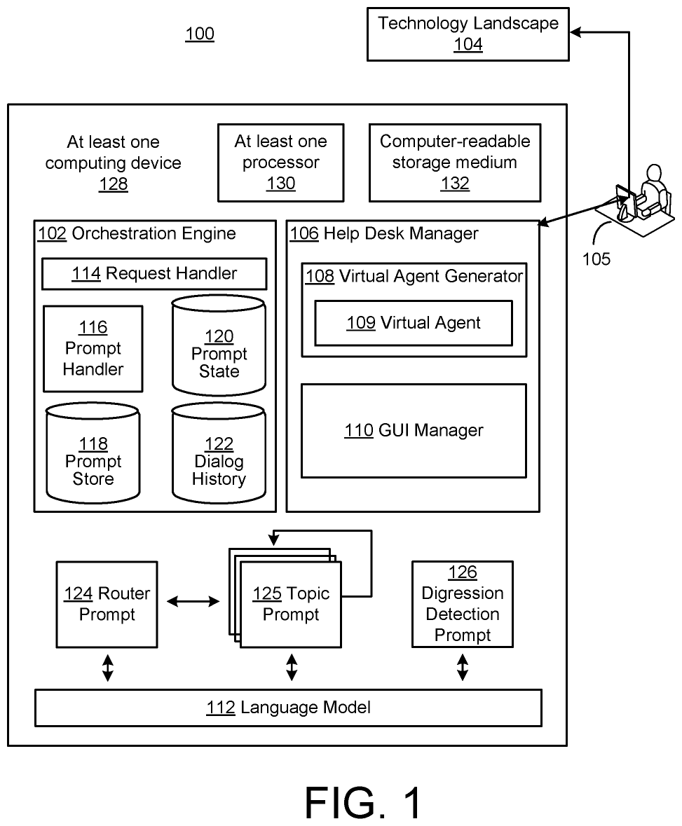

FIG. 1 is a block diagram of a system 100 for prompt orchestration for virtual agents with digression capabilities. In the example of FIG. 1, an orchestration engine 102 is configured to provide assistance for any issue arising in the context of an example technology landscape 104, for one or more users represented in FIG. 1 by a user 105.

In FIG. 1, the technology landscape 104 may represent any suitable context in which the user 105 may require assistance. For example, the technology landscape 104 may include many types of network environments, such as network administration of a private network of an enterprise, or a software application provided over the public internet, a wide area network, or other network. Technology landscape 104 may also represent scenarios in which sensors, such as internet of things devices (IoT), are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the technology landscape 104 may include, or reference, an individual IT component, such as a laptop or desktop computer or a server. In some embodiments the technology landscape 104 may represent a mainframe computing environment, or any computing environment of an enterprise or organization conducting network-based IT transactions.

For the sake of clarity and conciseness, various examples provided herein relate to an incident handling domain, such as IT incident handling or human resources (HR) incident handling. However, it will be appreciated that the system 100 of FIG. 1 may be implemented in any suitable domain, including, e.g., any context within a business, organizational, academic, legal, governmental, technical, or other setting in which users may require assistance.

For example, the user 105 may contact or interact with a help desk manager 106 that provides a point of interface for all users within the technology landscape 104. The help desk manager 106 may provide multiple various functions, such as tracking and storing information related to maintaining the technology landscape 104, including, e.g., anomaly alerts, remediation techniques, or incident handling queue, among other types of information. The help desk manager 106 may be further configured to assist in assigning and connecting human agents (not shown) to assist the user 105, when needed or requested by the user 105.

In FIG. 1, the help desk manager 106 is illustrated as including a virtual agent generator 108. For example, an instance of a virtual agent 109 may be generated in response to each request for assistance received from the user 105 determined by the help desk manager 106 to benefit from use of the virtual agent 109 (also referred to as a chatbot).

Also with respect to the help desk manager 106, a graphical user interface (GUI) manager 110 may be configured to provide one or more GUIs for use by the user 105 in interacting with the help desk manager 106. For example, the user 105 may submit an incident ticket or other request for assistant via a suitable GUI, together with a description of the incident or other relevant information. The user 105 may then interact with the virtual agent 109 generated and assigned by the virtual agent generator 108, using techniques described herein, to resolve the specified incident or otherwise obtain needed information.

Further in FIG. 1, a language model 112 represents one or more language models leveraged by the orchestration engine 102 to support operations of virtual agents, such as the virtual agent 109, generated by the virtual agent generator 108. For example, the language model 112 may represent an instance of a deep learning model pre-trained using large quantities of data. For example, the language model 112 may include one or more transformers (not shown in FIG. 1) that includes neural networks with self-attention capabilities. As described in more detail, below, the language model 112 may be implemented as an instruction-following large language model (LLM), which is trained on, and designed to reproduce, interactive and instruction-following behavior. Other types of LLMs may be used, as well.

Although models such as the language model 112 are capable of being trained in a generic manner across many different fields of knowledge, it may be difficult, expensive, or time-consuming to perform different, additional, or alternative training to enable more specialized operations of the language model 112. Moreover, to the extent that demands on the language model 112 may change over time, corresponding difficulties in modifying the language model 112 in response to such changing demands may be recurring.

In order to provide specialized operations associated with providing the virtual agent 109, including digression handling capabilities, the orchestration engine 102 may provide an intermediate layer between the virtual agent 109 and the language model 112. As described in more detail, below, the orchestration engine 102 may therefore provide customized request processing, which may be easily updated over time, and which is capable of handling multiple digressions initiated by the user 105, without requiring modifications to the language model 112.

In this regard, it will be appreciated that although the language model 112 is shown as a large language model, any current for future language model(s) may be used. For example, upon development or availability of a superior or new language model, the language model 112 may be replaced by such a new language model, or the new language model may be added to the system 100 for use in conjunction with the language model 112.

The orchestration engine 102 is illustrated as including a request handler 114. For example, as referenced above, the user 105 may represent a plurality of users and the virtual agent 109 may represent a corresponding plurality of instances of virtual agents. The request handler 114 may thus be configured to maintain correspondence between each user and each virtual agent, so that requests from the user 105 are routed accordingly for processing by the same virtual agent 109, even as many other requests from other users for other virtual agents are received.

A prompt handler 116 may be configured to chain two or more of a plurality of prompts from a prompt store 118 for submission to the language model 112. A prompt state 120 refers to a status of a given prompt within a resolution prompt. For example, a prompt may be in a state of waiting on user input from the user 105 for subsequent submission to the language model 112.

As described herein, a state of a first prompt may be saved in response to detection of a digression by the user 105 that requires use of a second prompt. Then, the state of the first prompt may be maintained while one or more digression topics and associated prompts are processed by the language model and the prompt handler 116. Once the one or more digression topics have been resolved, the prompt handler 116 may use the saved prompt state 120 to return to the first prompt. Digressions by the user 105 may occur at various times even after returning to a prior prompt state, and digressions may be interleaved with returns to a prior saved prompt state 120.

A dialog history 122 may be used to store conversational exchanges between the user 105 and the virtual agent 109, including, e.g., inputs to, and outputs from, the language model 112. The dialog history 122 may thus store individual conversations, e.g., from a time that the virtual agent 109 is instantiated until a time that resolution is reached. Saved dialogs may be used, e.g., to train the language model 112, to update chaining rules used by the prompt handler 116 to chain sequences of prompts, or to facilitate resolutions of a current incident or future incident.

In the example of FIG. 1, as referenced above, the prompt store 118 may store one or more prompt templates and one or more instantiated or configured prompts. For example, the prompt store 118 may store a router prompt 124, which may be configured to interact with the language model 112 to route user inputs, prompt inputs and/or outputs, and/or LLM inputs and/or outputs among one or more topic prompt(s) 125.

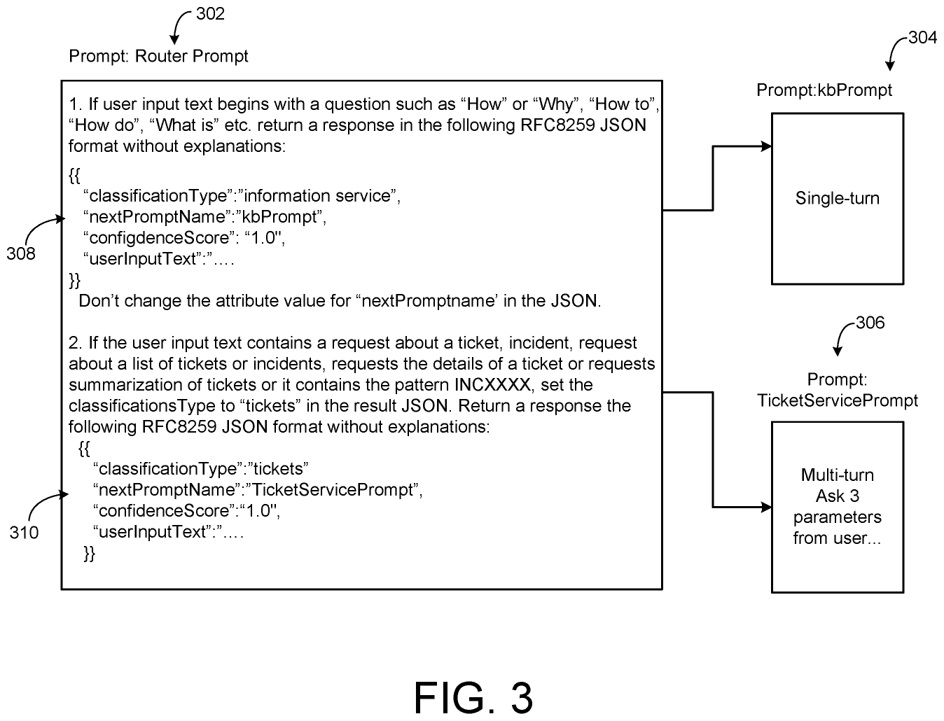

FIG. 3 provides a more detailed example of the router prompt 124, as well as more detailed examples of topic prompt(s) 125. In general, as just referenced, the router prompt 124 may receive a user input from the user 105, via the request handler 114 and the prompt handler 116. The router prompt 124 may then either process the user input to the language model 112, and/or may forward the user input to an appropriate one of the topic prompts 125. For example, the router prompt 124 may interact with the language model 112 to determine an appropriate one of the topic prompts 125 to be used for further processing.

Each of the topic prompts 125 may be assigned a defined subject matter or topic, along with parameters and procedures for utilizing the language model 112 to obtain relevant information for the specified subject matter. For example, a particular one of the topic prompts 125 may define a number of parameters to obtain from the user 105 and/or a number of associated conversational exchanges to conduct with the user 105. Such parameters may or may not be ordered and may or may not have dependencies on one another. A given one of the topic prompts 125 may further specify sources of relevant data, a nature of relevant data, or criteria for determining whether an obtained answer(s) is sufficient (or whether additional information from the user 105 is needed). A given topic prompt, upon reaching a defined resolution, may indicate a subsequent topic prompt for use in further processing (if needed), or may indicate a return to the router prompt 124, or may indicate that no further processing is needed.

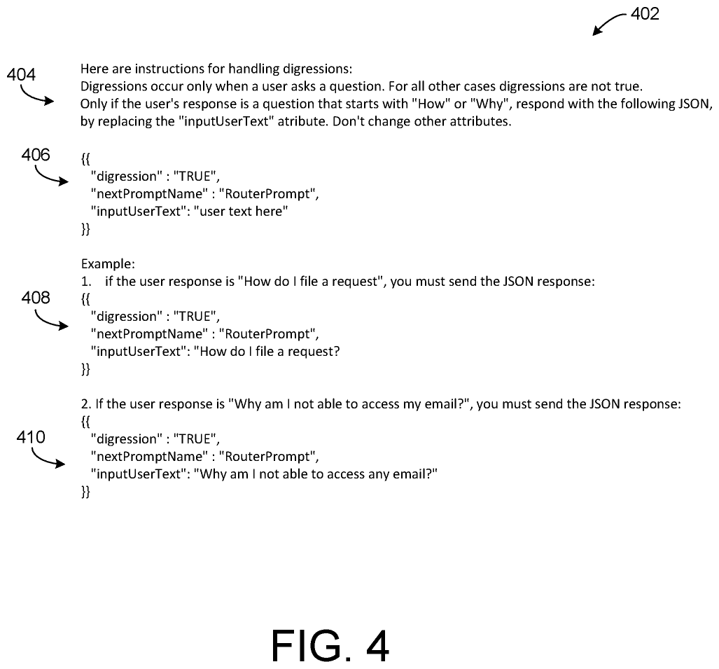

A digression detection prompt 126 is a specialized prompt that may be included with one, more than one, or all of the other prompts of the prompt store 118. The digression detection prompt 126 may be configured to define prompt aspects that may be detected by the language model 112 as indicating digression from a current topic (i.e., digression from a first one of the topic prompts 125 to a second one of the topic prompts 125). In some cases, digressions may be directed to the router prompt 124 to determine an appropriate prompt for a detected digression topic. A more detailed example of the digression detection prompt 126 is provided below, e.g., with respect to FIG. 4.

Thus, FIG. 1 illustrates that the system 100 may be used to provide virtual agent interactions that are natural and fluid. In contrast to existing systems, in which the virtual agent controls a flow of the conversation by asking questions and receiving answers, the system 100 enables human control of the conversation by the user 105, in that the user 105 can ask any question on any related topic and at any time during the conversation, at the discretion of the user 105.

In addition, the virtual agent 109 is able to obtain needed information based on declarative statements defining a general structure of information that might be helpful for a particular topic, without needed to script each conversational exchange. Put another way, the system 100 enables use of the orchestration engine 102 as an additional layer between the user 105 and the language model 112, which interprets information from the user 105 and from the language model 112. That is, the orchestration engine 102 provides a network of prompts from the prompt store 118 with the ability to jump dynamically and/or statically between the prompts to facilitate reasoning of the language model 112 in resolving the concerns of the user 105.

The illustrated structure of the system 100 of FIG. 1 should be understood to be by way of example only, and not limiting as to how described techniques may be implemented. For example, in FIG. 1, the orchestration engine 102 is illustrated separate from the virtual agent 109, but in other implementations, each instance of the virtual agent 109 may be assigned its own orchestration engine, or portions thereof.

In FIG. 1, the orchestration engine 102 is illustrated as being implemented using at least one computing device 128, including at least one processor 130, and a non-transitory computer-readable storage medium 132. That is, the non-transitory computer-readable storage medium 132 may store instructions that, when executed by the at least one processor 130, cause the at least one computing device 128 to provide the functionalities of the orchestration engine 102 and related functionalities.

For example, the at least one computing device 128 may represent one or more servers. For example, the at least one computing device 128 may be implemented as two or more servers or virtual machines in communications with one another over a network. Accordingly, the orchestration engine 102, the help desk manager 106, and the language model 112 may be implemented using separate devices in communication with one another.

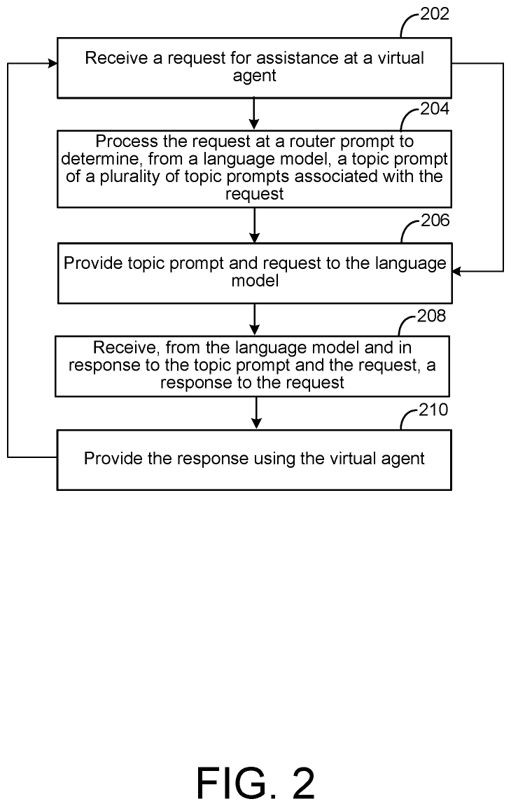

FIG. 2 is a flowchart illustrating example operations of the incident handling system 100 of FIG. 1. In the example of FIG. 2, operations 202 to 210 are illustrated as separate, sequential operations that include an iterative loop. In various implementations, the operations 202 to 210 may include sub-operations, may be performed in a different order, may include alternative or additional operations, or may omit one or more operations.

In FIG. 2, a request for assistance at a virtual agent may be received (202). For example, the virtual agent 109 may receive a request from the user 105 for assistance with any issue or challenge that might be experienced by the user 105 in the context of the technology landscape 104.

The request may be processed at a router prompt to determine, from a large language model, a topic prompt of a plurality of topic prompts associated with the request (204). For example, the request may be processed at the router prompt 124, or in the more detailed example router prompt of FIG. 3, including using the language model 112 to identify a topic prompt from available topic prompts 125 within the prompt store 118.

The topic prompt and the request may then be provided to the language model (206). Detailed examples of the topic prompt 125 of FIG. 1 are provided below with respect to FIGS. 3, 5, and 6.

A response to the request may be received from the language model and in response to the topic prompt and the request (208). Then, the response is provided using the virtual agent (210).

In some cases, the response may include a final resolution to an original request, in which case the process may end and/or return to a waiting state for a subsequent request (202). In other cases, a current topic prompt being used may specify multiple conversational turns, such as when the language model 112 and/or virtual agent 109 requests additional information from the user 105, in which case the response may include a request to the user 105 for the additional information for processing using the same or a current topic prompt (without requiring a return to the router prompt 124). Similarly, the response and/or the new request and/or information from the user 105 may be sufficient to determine that a new or different topic prompt 125 is needed, also without requiring intervening use of the router prompt 124. In such scenarios, when an additional request or other information is received from the user 105, the process may continue with providing a same or different topic prompt 125 and current request and/or information to the language model.

In other examples, however, the newly received request or information may require use of the router prompt 124 to determine which topic prompt 125 should be used, so that the process may continue with the determined topic prompt. In particular, when the newly received request or information is determined to be a digression (illustrated in more detail with respect to FIGS. 4, 6, and 7), the router prompt 124 may determine a next topic prompt 125 as a digression topic prompt, while saving a state of a current (pre-digression) topic prompt. As described herein, the process of FIG. 2 may then continue with the digression topic prompt until resolution is reached, whereupon the saved state of the pre-digression topic prompt may be used to resume the process of FIG. 2 with respect to the pre-digression topic prompt until resolution is reached there, as well. As also described, such approaches may be used to provide multiple nested levels of digression(s), so that the user 105 is able to choose any selected conversational topic desired at any given time, while still being able to return easily to earlier topics, as well.

FIG. 3 illustrates example prompts and prompt chaining used in the example system of FIG. 1. In FIG. 3, a router prompt 302 illustrates an example of the router prompt 124 of FIG. 1. A knowledge base (kb) prompt 304 and a ticket service prompt 306 illustrate examples of topic prompts 125 of FIG. 1.

As shown, the router prompt 302 includes first prompt detection text 308. The first prompt detection text 308 specifies an example that specifies to the language model 112 of FIG. 1 that if user input text begins with a question such as “How”, “Why”, “How to”, “How do”, or “What is”, then the language model 112 should return a response in the specified RFC8259 JSON format. As further shown, the response should include a classification type, a name of a next prompt, a confidence score, and the original user input text received. Upon return from the language model 112, the router prompt 302 in this example would receive instructions to route the received user input text to the kb prompt 304 for further processing.

Similarly, the second prompt detection text 310 specifies an example that specifies to the language model 112 of FIG. 1 that if user input text contains a request about a ticket or incident, a request about a list of tickets or incidents, requests the details of a ticket or requests summarization of tickets, or contains a specified pattern such as INCXXXX associated with incident tickets, then the language model 112 should return a response in the specified RFC8259 JSON format. As further shown, the response should include a classification type, a name of a next prompt, a confidence score, and the original user input text received. Upon return from the language model 112, the router prompt 302 in this example would receive instructions to route the received user input text to the ticket service prompt 306 for further processing.

In the example of FIG. 3, the kb prompt 304 is specified as a single-turn prompt, meaning that the routed user text would be submitted to the kb prompt 304 and thereby submitted with any additional parameters or data to the language model 112. The language model 112 would then provide a single response and, depending on the response, processing may either end, return to the router prompt 302, or proceed directly to a subsequent topic prompt.

In contrast, the ticket service prompt 306 is specified as a multi-turn prompt, meaning that the ticket service prompt 306 is constructed to interact with the language model 112 and the user 105 to conduct multiple conversational exchanges, e.g., to extract needed information from the user 105, using intermediate responses, for further processing. For example, the ticket service prompt 306 may specify conversational exchanges related to three parameters, such as, e.g., a time frame of an incident, an underlying resource related to the incident, or characteristics describing the incident.

As described herein, such exchanges do not need to be scripted as a sequence of queries, although the information (e.g., intermediate responses) may be gathered using a sequence of queries. For example, requests and responses may be executed in any order, and a total number of requests and/or responses may be fewer or greater than a number of parameters to be collected.

For example, the language model 112, via the virtual agent 109, may issue an initial query, such as “tell me more about the incident.” The user 105 may respond with two of the three parameters, whereupon the virtual agent 109, using the prompt 306 and the language model 112, may respond with a query for the remaining parameter. In other examples, the user 105 may provide partial information for a parameter, and the virtual agent 109 may reply with a request for a remainder of needed information.

In this way, the virtual agent 109 may proceed until all needed information has been obtained. Then, depending on the obtained information, processing may either end, return to the router prompt 302, or proceed directly to a subsequent topic prompt.

As may thus be observed, prompts may lead to multiple “NextPrompts” (shown as “nextPromptName” in FIGS. 3 and 4) based on the included, specified business logic of each prompt. Prompts are also declarative, in that each conversational turn need not be specified, but rather the goals of each conversational unit in each prompt may be specified.

The router prompt 302 may be understood as a zero-shot classifier of intents, in that the user 105 may submit a request with virtually any content or form, where the specific content/or form received may not fully match any previous input or any particular training data previously seen by the language model 112. The prompts 304, 306 provide examples of a set of prompts (e.g., in the prompt store 118 of FIG. 1) that each define a topic of conversation and execute actions corresponding to each determined, corresponding intent determined by the router prompt 302.

As further illustrated, each prompt may carry out a conversation and may be either a single turn prompt (such as the kb prompt 304) or a multi-turn prompt (such as the ticket service prompt 306) that allows the user 105 to ask multiple questions or otherwise interacts with the user 105 multiple times.

The prompts 302, 304, 306 further leverage the language model 112 to determine next prompt(s) to be used. The described modular prompt design allows for full flexibility of the conversation design, in which the flow may be determined by the user and not by predefined, rigid dialog flows.

Moreover, as referenced above, new prompts may be provided using a suitable prompt template and easily added to the prompt store 118 and to the router prompt 302. That is, a new prompt and corresponding high-level rules for conversations may be added, and the router prompt 302 may be modified to recognize the new prompt through the addition of new, corresponding prompt detection text.

FIG. 4 illustrates example prompt language for digression detection. As described above, prompts may be modeled as units of conversation that the user 105 may have on a topic, which allow the chatbot to shift smoothly to another prompt and/or topic at any time. Such shifts may occur as a result of an embedded “NextPromptName” indication, or as a user-initiated digression. While “NextPromptName” allows the chatbot to transition from one prompt to another chosen from a smaller subset of these pre-defined prompts, a digression allows the virtual agent 109 to change state by jumping to any prompt in the pre-defined set of prompts.

FIG. 4 illustrates a digression detection prompt 402, corresponding to an example of the digression detection prompt 126 of FIG. 1. The digression detection prompt 402 may be added to every other topic prompt(s) 125 when submitted to the language model 112. When the language model 112 detects a digression and reports the digression to the orchestration engine 102, the orchestration engine 102 may proceed to call a router prompt (e.g., the router prompt 124 of FIG. 1 or the router prompt 302 of FIG. 3) while storing a state of a prompt preceding the detected digression (e.g., using the prompt state 120 of FIG. 1). As described herein, the orchestration engine 102 may thus enable return to the stored prompt state following completion of the digression.

In FIG. 4, the digression detection prompt 402 includes instructions 404. As shown, the instructions specify that, in the example, digressions occur only when a user asks a question, and that for all other cases digressions are not true. Specifically, if the user's response is a question that starts with “How” or “Why”, the illustrated JSON may be provided in response, including replacing the “inputUserText” attribute, without changing other attributes, with the text received from the user 105.

Digression response code 406, generated in response to execution of the instructions 404, specifies that digression detection is ‘true’ and that the next prompt used should be the router prompt. Further, as referenced above, user text is forwarded to the router prompt for processing there.

The digression detection prompt 402 also includes examples 408, 410, which may be included for few-shot training of the language model 112 to increase response accuracy and completeness. As shown, the example 408 includes an example user question “How do I file a request?”, while the example 410 includes an example user question “Why am I not able to access any email?”

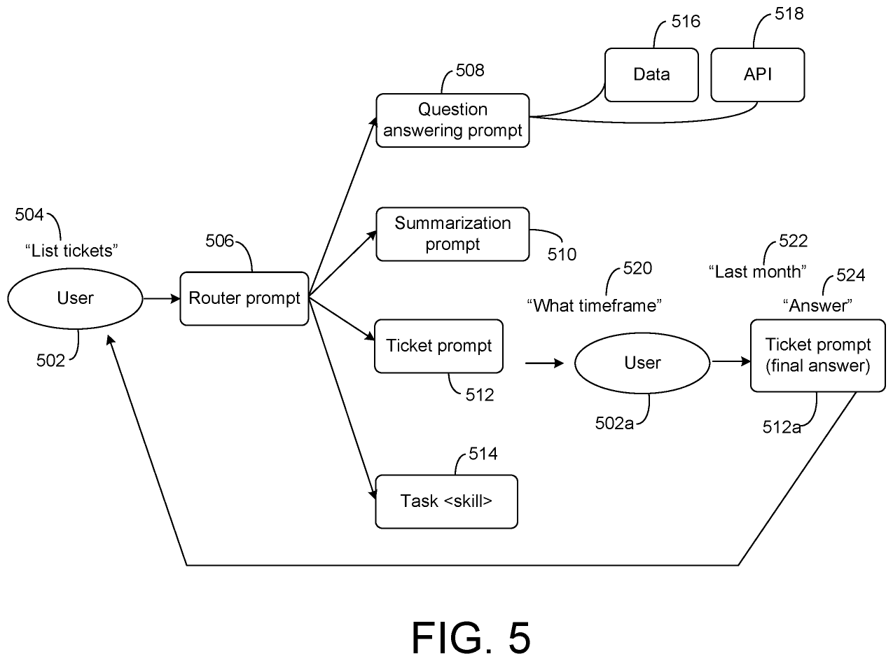

FIG. 5 is a block diagram illustrating a process flow for prompt chaining. In the example of FIG. 5, a user query 504 provides a user query 504 of “list tickets” to the orchestration engine 102 of FIG. 1. Related state and/or history information, if any, may be retrieved.

The orchestration engine 102 looks at the prompt information in the related state to determine which prompt to run. Upon session initialization, the state is initially set up to use router prompt 506 as the starting point for any conversation. The router prompt 506, as described with respect to FIG. 3, may classify the user query 504 to obtain intents, using a zero-shot classification. As also described, a language model, such as a large language model or other transformer-based model (e.g., the Bidirectional Encoder Representations from Transformers (BERT) model) may also be used.

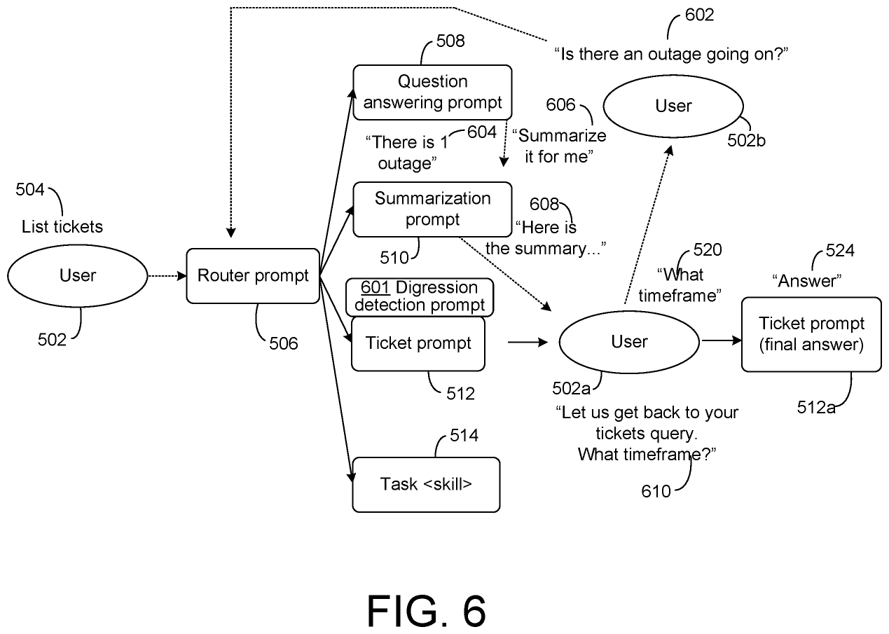

The router prompt 506 subsequently routes the user query 504 to a determined prompt from a set of available prompts, shown as a question answering prompt 508, summarization prompt 510, ticket prompt 512, and a generic or template task prompt 514. In FIG. 5, as well as in FIG. 6, below, it will be appreciated that each of the just-referenced prompts, as well as the router prompt 506, may interface with any needed data 516 and/or with the relevant language model(s) through an API 518. In FIG. 5, data 516 and API 518 are only illustrated as being accessible by the question answering prompt 508, for the sake of clarity and brevity.

In the example of FIG. 5, the language model 112 thus receives inputs including, e.g., the router prompt 506, the user query 504, relevant state information, and relevant conversation history, and determines a “next prompt.” Specifically, the next prompt in the example of FIG. 5 is the ticket prompt 512.

As illustrated in FIG. 3, the determined “next prompt” may be associated with a confidence score. If the confidence score is less than a threshold, or there is any ambiguity, the language model 112 may determine two or more most-plausible or highest-confidence prompts, and request clarification from the user 502.

Once the correct next prompt is obtained, the new prompt (e.g., ticket prompt 512) is sent to the language model 112 to manage the flow of the conversation. That is, the new prompt text, the user query 504, state information, and history information may be sent to the language model 112 for inference. If the user request 504 cannot be fulfilled by the new prompt for any reason, the user query 504 may be directed back to the orchestration engine and routing may be repeated or a new input received until an appropriate prompt is found, or until a defined maximum number of iterations is reached.

Otherwise, the virtual agent 109 may either ask the user a set of questions or provide the information requested as directed by the new prompt. For example, the user 502 (shown as user 502a for disambiguation) may be provided with a query 520 that requests a timeframe of the requested ticket list, whereupon the user 502a may provide a response 522 of “last month.” The ticket prompt 512a may thus return an answer 524 of listed tickets from the language model 112 and return control to the user 502 for any further questions.

FIG. 6 is a block diagram illustrating a process flow for prompt chaining with detected digression. Specifically, FIG. 6 illustrates the example of FIG. 5 (and therefore retains corresponding elements and reference numerals), but with a user-initiated digression to a different topic.

As shown, the process flow of FIG. 5 may proceed as described above, to the point of identifying the ticket prompt 512. As described with respect to FIG. 4, a digression detection prompt 601 may be submitted to the language model 112 in conjunction with submission of a topic prompt. That is, the digression detection prompt 601 is illustrated in FIG. 6 only with respect to the ticket prompt 512 for the sake of brevity, but should be understood to be included with potentially any or every prompt submitted to the language model 112 to ensure digression detection in conjunction with any submitted user response.

Thus, in FIG. 6, when the query 520 “what timeframe?” is returned by the ticket prompt 512 and the language model 112, the user (shown as 502b for disambiguation) responds with a digression request 602 of “Is there an outage going on?” Upon resulting digression detection, the state of the ticket prompt 512 is saved as including the query 520 of “What timeframe?”, and the digression request 602 is returned to the router prompt 506 to be processed as described above with respect to the original user query 504. It will be appreciated that the digression request 602 refers to any request (e.g., query) that, upon receipt, is determined to be a digression with respect to a current topic being processed.

In the example of FIG. 6, processing of the digression request 602 includes routing (using the routing prompt 506) the digression request 602 to the question answering prompt 508, which (together with the language model 112) responds with response 604 of “there is one outage.” The user 502b responds with a related query 606 of “Summarize it for me,” which is sent to the summarization prompt 510 to obtain a result 608 of “Here is the summary . . . .”

Upon determining that the result 608 is a final answer to the digression or otherwise determining that the digression has ended, the pre-digression state is retrieved and the user is provided with a reiteration of, and return to, the query 520, shown in FIG. 6 as a post-digression query 610 of “Let us get back to your tickets query. What timeframe?” Processing may then continue as described with respect to FIG. 5 to obtain the answer 524 with respect to the user query 504.

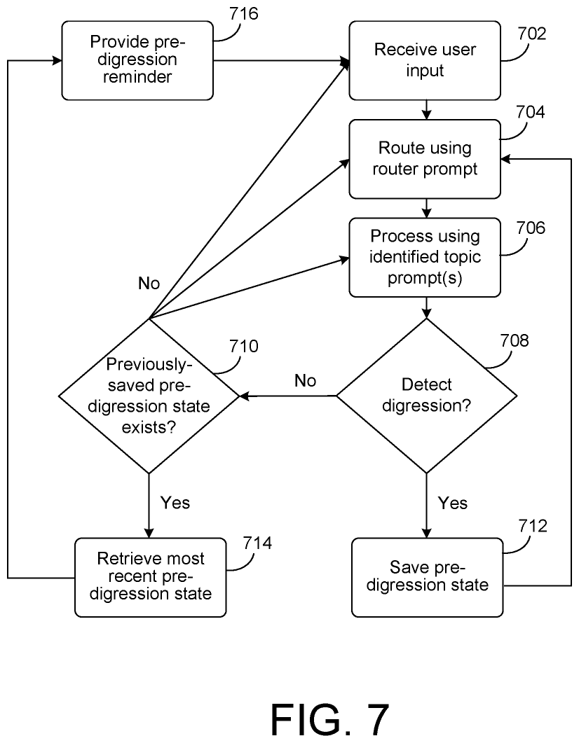

FIG. 7 is a flowchart illustrating more detailed example operations of the system of FIG. 1. In the example of FIG. 7, user input is received (702) and is initially routed using a router prompt (704). One or more identified topic prompts may thus be used for processing (706). As described with respect to FIG. 5, such processing may include multiple conversational exchanges with a user until a final answer is reached.

Thus, as long as no digression is detected (708), and as long as no previously-saved pre-digression state has previously been saved (710), then processing may continue (702, 704, 706). That is, for example, a user may receive a series of resolutions for corresponding issues/incidents using described techniques.

If a digression is detected (708), that is, if receipt of a digression request is detected, then the pre-digression state may be saved (712). For example, as described with respect to FIG. 6, a current prompt and currently requested information (e.g., a current query) may be saved. Control may then be passed to the router prompt (704) to proceed with attempted resolution of the digression and associated digression topics (706).

If a second digression is detected (708) from the first digression, then the current (first) digression state may be saved as a pre-digression state for the second digression (712). Once the second digression is resolved (704, 706), and assuming no third digression is detected (708), then the previously saved first digression state may be determined to exist (710) and may be retrieved (714). The corresponding query or response obtained from the state information may thus be provided back to the user as a reminder (716), whereupon corresponding user input may be received (702) and processing may continue (704, 706) until resolution of the first digression is reached.

In the example, the above process may be repeated to return to the saved stated prior to the first digression (i.e., an original query), and to thereby complete processing of the original query. In this way, any number of digressions may be maintained for nested processing.

As described herein, provided techniques enable intent recognition based on semantics embedded in language model prompts, and aided by user input in some scenarios. Although reinforcement by additional examples is possible, no further training of the underlying language model is needed.

Existing frameworks for chaining language model prompts require rigid scripting of such prompts, whereas described techniques enable dynamic chaining including jumping from any prompt to any other prompt, e.g., using a “next prompt” output.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, mainframe computer(s), or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive a request at a virtual agent;
process the request at a router prompt to determine, from a language model, a topic prompt of a plurality of topic prompts associated with the request;
provide the topic prompt and the request to the language model;
receive, from the language model and in response to the topic prompt and the request, a response to the request; and
provide the response using the virtual agent.

2. The computer program product of claim 1, wherein the topic prompt defines at least two conversational exchanges, and wherein the instructions, when executed, are further configured to cause the at least one computing device to:
obtain, via the virtual agent, intermediate responses to the at least two conversational exchanges; and
provide the response based on the intermediate responses.

3. The computer program product of claim 1, wherein the instructions, when executed, are further configured to cause the at least one computing device to:
receive, following providing the response using the virtual agent, a second request; and
provide the second request to the router prompt.

4. The computer program product of claim 1, wherein the instructions, when executed, are further configured to cause the at least one computing device to:
detect a digression request; and
provide the digression request to the router prompt.

5. The computer program product of claim 4, wherein the instructions, when executed, are further configured to cause the at least one computing device to:
determine, at the router prompt, a digression topic prompt from the plurality of topic prompts; and
provide the digression topic prompt and the digression request to the language model.

6. The computer program product of claim 5, wherein the instructions, when executed, are further configured to cause the at least one computing device to:
receive, from the language model and in response to the digression topic prompt and the digression request, a digression response to the digression request; and
provide the digression response using the virtual agent.

7. The computer program product of claim 6, wherein the instructions, when executed, are further configured to cause the at least one computing device to:
save, in response to detecting the digression request, a state of the topic prompt prior to receipt of the digression request; and
return, after providing the digression response, to the state of the topic prompt prior to receipt of the digression request.

8. The computer program product of claim 7, wherein the instructions, when executed, are further configured to cause the at least one computing device to:
provide, when returning to the state of the topic prompt and using the virtual agent, a pre-digression reminder referencing the topic prompt.

9. The computer program product of claim 1, wherein the instructions, when executed, are further configured to cause the at least one computing device to:
provide the topic prompt and the request to the language model together with a digression prompt configured to use the language model to determine a digression from a topic of the topic prompt prior to providing the response.

10. The computer program product of claim 1, wherein the language model includes a large language model.

11. A computer-implemented method, the method comprising:
receiving a request at a virtual agent;
processing the request at a router prompt to determine, from a language model, a topic prompt of a plurality of topic prompts associated with the request;
providing the topic prompt and the request to the language model;
receiving, from the language model and in response to the topic prompt and the request, a response to the request; and
providing the response using the virtual agent.

12. The method of claim 11, further comprising:
detecting a digression request; and
providing the digression request to the router prompt.

13. The method of claim 12, further comprising:
determining, at the router prompt, a digression topic prompt from the plurality of topic prompts; and
providing the digression topic prompt and the digression request to the language model.

14. The method of claim 13, further comprising:
receiving, from the language model and in response to the digression topic prompt and the digression request, a digression response to the digression request; and
providing the digression response using the virtual agent.

15. The method of claim 14, further comprising:
saving, in response to detecting the digression request, a state of the topic prompt prior to receipt of the digression request; and
returning, after providing the digression response, to the state of the topic prompt prior to receipt of the digression request.

16. The method of claim 15, further comprising:
providing, when returning to the state of the topic prompt and using the virtual agent, a pre-digression reminder referencing the topic prompt.

17. The method of claim 11, further comprising:
providing the topic prompt and the request to the language model together with a digression prompt configured to use the language model to determine a digression from a topic of the topic prompt prior to providing the response.

18. A system comprising:
at least one memory including instructions; and
at least one processor that is operably coupled to the at least one memory and that is arranged and configured to execute instructions that, when executed, cause the at least one processor to:
receive a request at a virtual agent;
process the request at a router prompt to determine, from a language model, a topic prompt of a plurality of topic prompts associated with the request;
provide the topic prompt and the request to the language model;
receive, from the language model and in response to the topic prompt and the request, a response to the request; and
provide the response using the virtual agent.

19. The system of claim 18, wherein the instructions, when executed, are further configured to cause the at least one processor to:
detect a digression request;
save, in response to detecting the digression request, a state of the topic prompt prior to receipt of the digression request;
determine, at the router prompt, a digression topic prompt from the plurality of topic prompts;
provide the digression topic prompt and the digression request to the language model;
receive, from the language model and in response to the digression topic prompt and the digression request, a digression response to the digression request;
provide the digression response using the virtual agent; and
return, after providing the digression response, to the state of the topic prompt prior to receipt of the digression request.

20. The system of claim 18, wherein the instructions, when executed, are further configured to cause the at least one processor to:
provide the topic prompt and the request to the language model together with a digression prompt configured to use the language model to determine a digression from a topic of the topic prompt prior to providing the response.
